(19) United States
(12) Patent Application Publication
(10) Pub. No.: US 2018/0159918 A1
(43) Pub. Date: Jun. 7, 2018

(54) SYSTEM AND METHOD FOR COORDINATING COMMUNICATION DURING REAL-TIME EVENT

(71) Applicant: K2 ECONOMICS, INC., Glendale, CA (US)

(72) Inventors: Arsine Christine Khayoyan, Glendale, CA (US); Jack Hagop Khayoyan, Glendale, CA (US)

(21) Appl. No.: 15/828,351

(22) Filed: Nov. 30, 2017

Related U.S. Application Data
(60) Provisional application No. 62/428,993, filed on Dec. 1, 2016.

(51) Int. Cl. H04L 29/08

(52) U.S. Cl. CPC H04L 67/10; H04L 51/04

(57) ABSTRACT

According to some example embodiments, a communication system includes: a processor; and a memory coupled to the processor, wherein the memory stores instructions that, when executed by the processor, cause the processor to: receive data corresponding to a media event, the data comprising information corresponding to a plurality of sub-events occurring during the media event; transmit the information corresponding to the plurality of sub-events to a first electronic device operated by a first user; receive, from the first electronic device, a signal indicating approval or disapproval, by the first user, of an outcome associated with a sub-event from among the sub-events; and transmit a signal, to a second electronic device associated with a second user, including information about the approval or disapproval, by the first user, of the outcome associated with the sub-event.

### CROSS-REFERENCE TO RELATED APPLICATIONS

This application claims priority to and the benefit of U.S. Provisional Patent Application No. 62/428,993, entitled “SYSTEM AND METHOD FOR COORDINATING COMMUNICATION DURING REAL-TIME EVENT”, filed in the United States Patent and Trademark Office on Dec. 1, 2016, the entire content of which is incorporated herein by reference.

### FIELD

Aspects of embodiments of the present invention relate to a system and method for coordinating communication during a real-time event.

### BACKGROUND

In recent years, personal electronic devices (such as smartphones, personal computers, tablet computers, etc.) have become a ubiquitous part of modern life. For example, many personal electronic devices serve as a convenient avenue to enable users to consume media content, such as television programs, movies, music, radio programs, podcasts, and the like. Advances in computer and display technology, and digital communication infrastructure, have enabled personal electronic devices to become a mechanism for users to receive and consume digital media more easily and faster than ever before. Additionally, many people rely on their personal electronic devices as a means for communicating with friends, family, and acquaintances.

The above information discussed in this Background section is only for enhancement of understanding of the background of the described technology and therefore it may contain information that does not constitute prior art that is already known to a person having ordinary skill in the art.

### SUMMARY

Aspects of some example embodiments of the present invention relate to a system and method for coordinating communication during a real-time event.

According to some example embodiments, a communication system includes: a processor; and a memory coupled to the processor, wherein the memory stores instructions that, when executed by the processor, cause the processor to: receive data corresponding to a media event, the data comprising information corresponding to a plurality of sub-events occurring during the media event; transmit the information corresponding to the plurality of sub-events to a first electronic device operated by a first user; receive, from the first electronic device, a signal indicating approval or disapproval, by the first user, of an outcome associated with a sub-event from among the sub-events; and transmit a signal, to a second electronic device associated with a second user, including information about the approval or disapproval, by the first user, of the outcome associated with the sub-event.

According to some embodiments, the instructions further cause the processor to receive, from a plurality of electronic devices including the first and second electronic devices, signals indicating approval or disapproval, by corresponding users of the plurality of electronic devices, of the outcome associated with the sub-event.

According to some embodiments, the instructions further cause the processor to transmit a signal to each of the plurality of electronic devices indicating a collective level of agreement or disagreement of the by the corresponding users of the plurality of electronic devices.

According to some embodiments, the instructions further cause the processor to: receive a signal including a text-based communication message from the first electronic device; and transmit information about the text-based communication message to the second electronic device for display thereby.

According to some embodiments, the instructions further cause the processor to: receive a signal regarding playback progress of the media event; and transmit the information corresponding to the plurality of sub-events according to the playback progress of the media event.

According to some embodiments, the instructions further cause the processor to: receive, from the first electronic device, a signal indicating initiation of playback of the media event; and transmit the information corresponding to the plurality of sub-events to the first electronic device in response to receiving the signal indicating initiation of playback of the media event.

According to some embodiments, the instructions further cause the processor to: receive, from the first electronic device, a signal including information about a reason for the approval or disapproval of the outcome associated with the sub-event; and transmit the information about the reason for approval or disapproval of the outcome associated with the sub-event to the second electronic device for display thereby.

According to some embodiments, the instructions further cause the processor to: receive, from the first electronic device, a signal including information indicating a missed call during the media event; and transmit the information indicating the missed call to the second electronic device for display thereby.

According to some embodiments, the instructions further cause the processor to: receive, from the first electronic device, a signal including information about a reason for the missed call during the media event; and transmit the information about the reason for the missed call to the second electronic device for display thereby.

According to some embodiments, the instructions further cause the processor to: store information about approval or disapproval, by the first user, of outcomes associated with multiple sub-events from among the plurality of sub-events; and transmit a signal to the first electronic device for displaying a summary of the approval or disapproval of the outcomes associated with the multiple sub-events.

According to some example embodiments, a communication method includes: receiving, by a processor, data corresponding to a media event, the data comprising information corresponding to a plurality of sub-events occurring during the media event; transmitting, by the processor, the information corresponding to the plurality of sub-events to a first electronic device operated by a first user; receiving, by the processor, from the first electronic device, a signal indicating approval or disapproval, by the first user, of an outcome associated with a sub-event from among the sub-events; and transmitting, by the processor, a signal, to a second electronic device associated with a second user, including information about the approval or disapproval, by the first user, of the outcome associated with the sub-event.

According to some embodiments, the method further includes receiving, by the processor, from a plurality of electronic devices including the first and second electronic devices, signals indicating approval or disapproval, by corresponding users of the plurality of electronic devices, of the outcome associated with the sub-event.

According to some embodiments, the method further includes transmitting, by the processor a signal to each of the plurality of electronic devices indicating a collective level of agreement or disagreement of the by the corresponding users of the plurality of electronic devices.

According to some embodiments, the method further includes: receiving, by the processor, a signal including a text-based communication message from the first electronic device; and transmitting, by the processor, information about the text-based communication message to the second electronic device for display thereby.

According to some embodiments, the method further includes: receiving, by the processor, a signal regarding playback progress of the media event; and transmitting, by the processor, the information corresponding to the plurality of sub-events according to the playback progress of the media event.

According to some embodiments, the method further includes: receiving, by the processor, from the first electronic device, a signal indicating initiation of playback of the media event; and transmitting, by the processor, the information corresponding to the plurality of sub-events to the first electronic device in response to receiving the signal indicating initiation of playback of the media event.

According to some embodiments, the method further includes: receiving, by the processor, from the first electronic device, a signal including information about a reason for the approval or disapproval of the outcome associated with the sub-event; and transmitting, by the processor, the information about the reason for approval or disapproval of the outcome associated with the sub-event to the second electronic device for display thereby.

According to some embodiments, the method further includes: receiving, by the processor, from the first electronic device, a signal including information indicating a missed call during the media event; and transmitting, by the processor, the information indicating the missed call to the second electronic device for display thereby.

According to some embodiments, the method further includes: receiving, by the processor, from the first electronic device, a signal including information about a reason for the missed call during the media event; and transmitting, by the processor, the information about the reason for the missed call to the second electronic device for display thereby.

According to some embodiments, the method further includes: storing, by the processor, information about approval or disapproval, by the first user, of outcomes associated with multiple sub-events from among the plurality of sub-events; and transmitting, by the processor, a signal to the first electronic device for displaying a summary of the approval or disapproval of the outcomes associated with the multiple sub-events.

### BRIEF DESCRIPTION OF THE DRAWINGS

A more complete appreciation of the present invention, and many of the attendant features and aspects thereof, will become more readily apparent as the invention becomes better understood by reference to the following detailed description when considered in conjunction with the accompanying drawings in which like reference symbols indicate like components, wherein:

FIGS. 1A and 1B illustrate example block diagrams of a plurality of electronic devices in electronic communication over a network, according to some example embodiments of the present invention;

FIG. 2 illustrates a relational database structure operating as part of a system for coordinating communication during a real time event, according to some example embodiments of the present invention;

FIGS. 3A-3GG illustrate example screen shots of a user interface for a system and method for coordinating communication during a real time event, according some example embodiments of the present invention;

FIG. 4 is a flow diagram illustrating a process for coordinating communication during a real time event, according to some example embodiments of the present invention;

FIG. 5A is a block diagram of a computing device according to an embodiment of the present invention;

FIG. 5B is a block diagram of a computing device according to an embodiment of the present invention;

FIG. 5C is a block diagram of a computing device according to an embodiment of the present invention;

FIG. 5D is a block diagram of a computing device according to an embodiment of the present invention; and

FIG. 5E is a block diagram of a network environment including several computing devices according to an embodiment of the present invention.

### DETAILED DESCRIPTION

The present invention is described in one or more embodiments in the following description with reference to the figures, in which like numerals represent the same or similar elements. While the invention is described in terms of the best mode of carrying out the invention, it will be appreciated by those skilled in the art that it is intended to cover alternatives, modifications, and equivalents as may be included within the spirit and scope of the invention as defined by the appended claims and their equivalents as supported by the following disclosure and drawings.

In general terms, embodiments of the present invention are directed to a system and method of coordinating communication during real time events. In particular, embodiments of the present invention provide a graphical interface through which users can interact and communicate with one another, for example, in real time during an event or media broadcast.

According to embodiments of the present invention, an interface or software application or module may be downloaded and/or executed on an electronic display device, such as a smartphone, personal computer, or tablet. During execution of the module, users are enabled to receive data from a central server system or distributed server network regarding or related to an event, for example, a live or ongoing sporting event, and also exchange data or communications with other users operating the module on their own electronic display device.

According to some example embodiments, the system may operate, for example, as a social media application for sports fans, enabling users to engage with other users about a sporting event in real time, and in particular to interact with one another regarding the performance or quality of referees or officials. Thus, some embodiments of the present invention operate to provide a platform for enabling sports fans to engage one another regarding referee performance. For example, according to some embodiments, referee calls or actions can be voted on in real-time, and discussed with other users. Additionally, some embodiments of the present invention provide a mechanism through which various users can “tailgate” with one another, or engage in a group or community instant message chat session with other users.

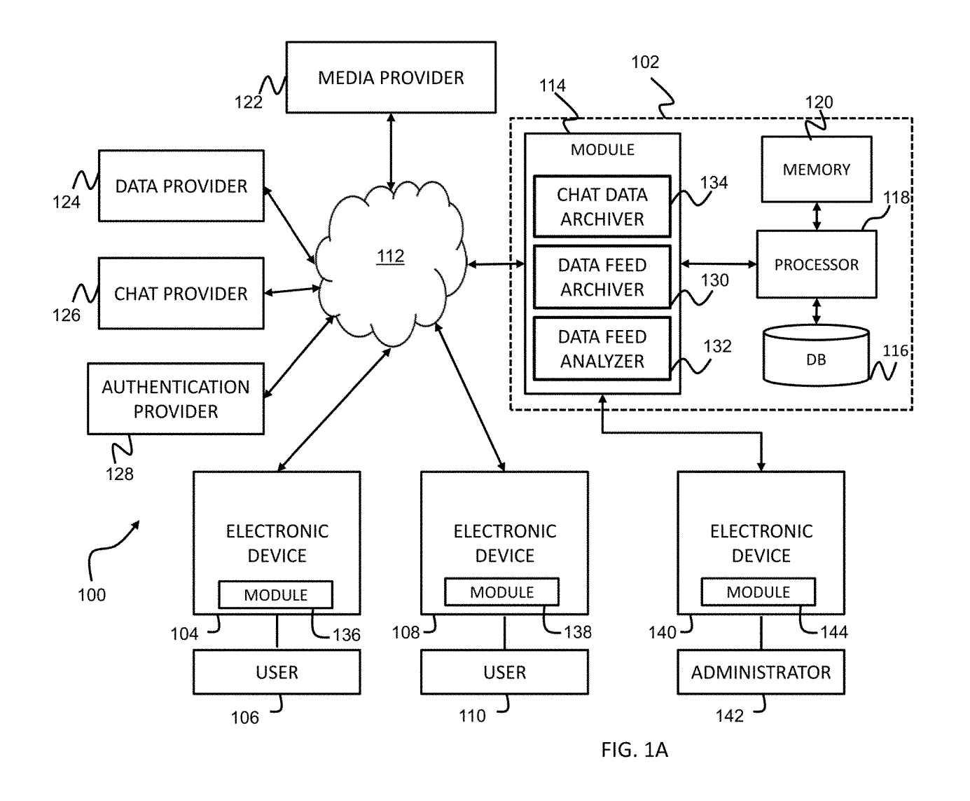

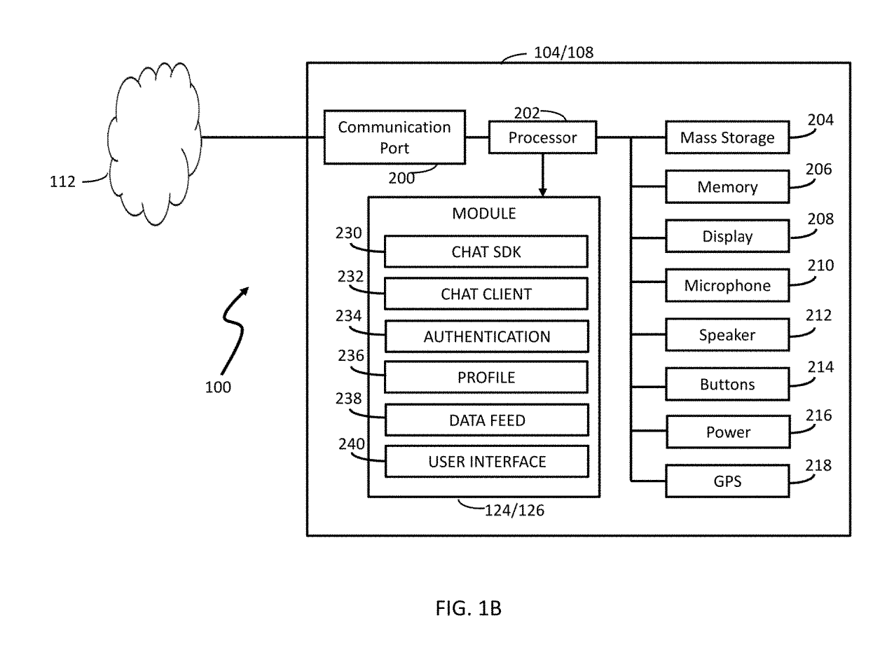

FIGS. 1A and 1B illustrate example block diagrams of a plurality of electronic devices in electronic communication over a network as part of a communication system 100, according to some example embodiments of the present invention. The communication system 100 includes a communication server 102, an electronic device 104 operated by a user 106, and an electronic device 108 operated by a user 110. The users 106 and 110 may be for example fans of a particular sports team or sporting event, and may operate the electronic devices 104 and 108 in real-time during a sporting event, and also between events to communicate with one another. The number of electronic devices 104 and 108 and users 106 and 110 may vary according to the design of the communication server 102 and the communication system 100, and are not limited to the number illustrated in FIG. 1A.

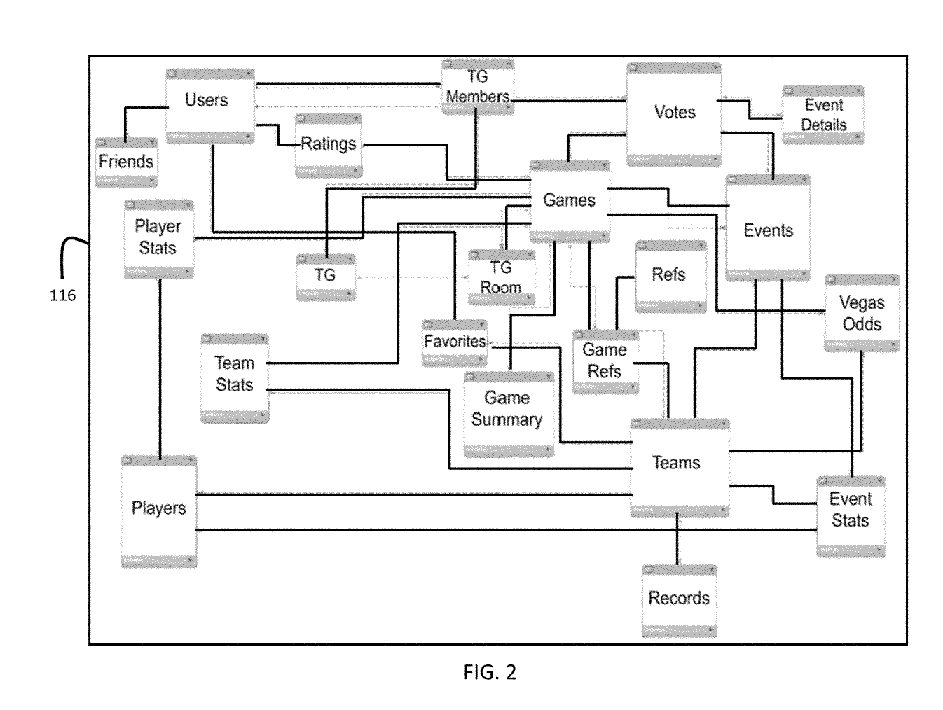

The communication server 102 is connected to (i.e., in electronic communication with) the plurality of electronic devices 104 and 108 over a data communications network 112 such as, for example, a local area network or a wide area network (e.g., a public Internet). The communication server 102 includes one or more software modules (e.g., module 114, described in more detail below) for coordinating communications and interactions between the users 106 and 110. The communication server 102 is also connected to or includes a mass storage device or database 116 such as, for example, a disk drive, drive array, flash memory, magnetic tape, or other suitable mass storage device for storing information used by the communication server 102. For example, the mass storage device 116 may store personal profile information about the users 106 and 110 operating the electronic devices 104 and 108, such as contact information, unique identification information, financial institution information, previous interaction information, and other contextual information regarding the users 106 and 110 or the electronic devices 104 and 108 that may be relevant to facilitating interactions between the users 106 and 110. Further details of the database 116 are described below with respect to FIG. 2.

The communication server 102 further includes a processor or central processing unit (CPU) 118, which executes program instructions and interacts with other system components to perform various methods and operations according to embodiments of the present invention. Additionally, the CPU 118 may include (or be in electronic communication with), for example, a graphics processing unit (GPU) for processing signals and data to display images on a display.

The communication server 102 further includes a memory 120, which operates as an addressable memory unit for storing software instructions to be executed by the CPU 118. The memory 120 is implemented using any suitable memory device, such as a random access memory (RAM), and may additionally operate as a computer-readable storage medium having non-transitory computer readable instructions stored therein that when executed by a processor cause the processor to control and manage interactions and facilitate communications between the users 106 and 110 using the electronic devices 104 and 108, the communication module 114, and in some embodiments, one or more media providers 122, data providers 124, chat providers 126, and authentication providers 128 over the data communications network 112. The number of media providers 122, data providers 124, chat providers 126, and authentication providers 128 may vary according to the design of the communication system 100, and is not limited to the numbers illustrated in FIG. 1A.

The media providers 122 may include, for example, any third party media networks or providers generating media regarding real time events (e.g., sporting events). For example, the media providers 122 may include television stations providing live or time-delayed video streams of sporting events.

The data providers 124 may include, for example, any third party platform or server configured to collect data regarding real-time events. For example, during the course of a real-time event, data entry personnel may monitor the event and transmit data about the event to the data provider 124. In the context of a real time sporting event, data entry personnel, operating electronic devices that are in electronic communication with the data provider 124, are often positioned near the sidelines or in media boxes for observing the sporting event. The data entry personnel utilize their electronic devices to transmit statistics about athletes' performances, time outs, referee calls, and the like, to the data provider 124. The data provider 124 may then provide a mechanism to receive a data stream of the statistics generated during the real-time event. For example, the data provider 124, in exchange for paying a licensing or subscription fee, may enable other parties to access the data stream, for example, by way of an Application Programming Interface (API), or other mechanism. Thus, according to some embodiments, the communication server 102 (and the module 114) may be in communication with the data provider 124 for receiving statistical data regarding real-time events.

Additionally, the module 114 may include a data feed archiver 130, configured to receive the data provided by the data provider 124 and store the data in the database 116. The sports feed archiver 130 may further interact with a data feed analyzer 132 operating as part of the module 114. The sports feed archiver 130 and/or the data feed analyzer 132 may be configured to, for example, translate or convert the data provided by the data provider 124 to a state or format that can be utilized and displayed by the electronic devices 104 and 108 for display to users 106 and 110.

The chat provider 126 may include a chat server or platform for facilitating text-based communication between users. According to some embodiments, the chat provider 126 may operate as part of the communication server 102, or may be an external system (e.g., a third party chat provider) in electronic communication with the communication server 102 and/or the electronic devices 104 and 108.

Additionally, the module 114 may include a chat data archiver 134 configured to receive chat communication data exchanged between users (e.g., users 106 and 110) during the course of a communication session and/or a real-time event. Additionally, the chat data archiver 134 and/or the module 114 may operate as an intermediary for transmitting chat communications between electronic devices operated by users for display by modules 136 and 138 operating on electronic devices 104 and 108, respectively.

The authentication provider 128 may include an authentication platform or server configured to authenticate users' identities using personal identification data and/or other password or unique token information. In some embodiments, the authentication provider 128 may be configured to operate as a primary authentication platform, in which an encrypted data stream that includes personal identification data (e.g., username and password data) is transmitted from users' electronic devices to the authentication provider 128. Users' passwords and usernames may be stored at the authentication provider 128, and unique authentication tokens may be transmitted to the communication server 102 for authorizing user access to the communication system 100, after users' identities are verified. Alternatively, in some embodiments, the authentication provider 128 may be managed and controlled by the communication system 100. When logging into the module 136 or 138 in order to interact with the communication server 102, the electronic device 104 or 108 may exchange identification, password, and/or token data with the authentication provider 128 to authenticate the users' identity prior to authorizing the electronic device 104 or 108 to access the communication server 102.

Additionally, according to some example embodiments, the communication system 100 includes an electronic device 140 operated by an administrator or agent 142 of the communication system 100. The number of electronic devices 140 and administrators 142 may vary according to the design of the communication system 100 and is not limited to the number illustrated in FIG. 1A. The electronic device 140 is connected to (i.e., in electronic communication with) the communication server 102. A communication module 144 may be installed on and/or accessible as a software module on the electronic device 140 to facilitate communication between the administrator(s) and/or the users of the communication system 100, and to facilitate monitoring and controlling the communication system 100 by the administrators 142. For example, according to some example embodiments, the communication module 144 may be configured to display a user interface for testing, analyzing, and administering the communication system 100.

According to some embodiments of the present invention, the electronic devices 104 and 108 may connect to the data communications network 112 using a telephone connection, satellite connection, cable connection, radio frequency communication, or any suitable wired or wireless data communication mechanism. To this end, the electronic devices 104 and 108 may take the form of, for example, a personal computer (PC), handheld personal computer (HPC), personal digital assistant (PDA), tablet or touch screen computer system, telephone, cellular telephone, smartphone, or any suitable consumer electronics device.

The communication server 102 operates as a mechanism to enable the users 106 and 110 to communicate with one another using their respective electronic devices 104 or 108, and also, for example, to receive information about and/or during various events, such as live sporting events. As will be discussed in more detail below, communication modules 136 and 138 may be installed and/or executed as software modules on the electronic devices 104 and 108, respectively, to facilitate communication between the users via the communications network 112, the communication server 102, and the media provider 122. According to some embodiments, the communication server 102 and/or the electronic devices 104 and 108 may also receive data from one or more third party data providers 124, for example, regarding an event. For example, third party data providers 124 may include statistics aggregators, sportsbooks, news agencies, and the like.

FIG. 1B illustrates further detail of an example electronic device 104 operating as part of the communication system 100, according to some embodiments of the present invention. The electronic device 108 may have the same or similar components as the electronic device 104. The electronic devices 104 and 108 may include additional components or fewer components according to the design of the communication system 100. The electronic device 104 includes a communication port 200, which is in electronic communication with the network 112 for sending and receiving data signals to other electronic devices 104 and the server 102. The communication port 200 represents one or more electronic communication data ports capable of sharing input and output data with external devices. Communication port 200 can be configured to receive data cables with a wired interface such as high-speed Ethernet, Universal Serial Bus (USB), High-Definition Multimedia Interface (HDMI), or other similar analog or digital data interface. Alternatively, communication port 200 may be configured to receive and transmit input and output (I/O) data wirelessly, for example, using available electromagnetic spectrum.

The communication port 200 is in electronic communication with a processor 202 of the electronic device 104 for processing data received by the communication port 200 and for transmitting data processed by the processor 202 to appropriate devices connected to the network 112.

The electronic device 104 further includes several other components that are controlled by the processor 202. For example, mass storage device or hard disk 204 is electrically connected to the processor 202 for storing data files on non-volatile memory for future access by the processor 202. The mass storage device 204 can be any suitable mass storage device such as a hard disk drive (HDD), flash memory, secure digital (SD) memory card, magnetic tape, compact disk, or digital video disk. The electronic device 104 further includes electronic memory 206 for addressable memory or RAM data storage. Collectively, the processor 202, mass storage device 204, and electronic memory 206 may operate to facilitate communications in conjunction with the communication server 102, such that the electronic memory 206 operates as a computer-readable storage medium having non-transitory computer readable instructions stored therein that when executed by the processor 202 cause the processor 202 to control sending and receiving data to exchange communications according to user input received through the electronic device 104.

A display 208 is positioned externally on the electronic device 104 to facilitate user interaction with the electronic device 104. The display 208 may be a light-emitting diode (LED) display, liquid crystal display (LCD), organic LED display, or other suitable display capable of graphically displaying information and images to users. In one embodiment the display is a touch screen display capable of sensing touch input from users.

In one embodiment, the electronic device 104 further includes a microphone 210 and a speaker 212 for receipt and playback of audio signals. One or more buttons 214 (or other input devices such as, for example, keyboard, mouse, joystick, etc.) enable additional user interaction with the electronic device 104. The electronic device 104 further includes a power source 216, which may include a battery or may be configured to receive an alternating or direct current electrical power input for operation of the electronic device 104. The electronic device may further include a global position system (GPS) sensor 218 for transmitting electronic signals to and receiving electronic signals from orbiting satellites to calculate the geographical location of the electronic device 104.

Additionally, as discussed above, the electronic devices 104 and 108 may include a module 124 or 126, respectively, that is installed locally on or accessible by the electronic devices 104 and 108 for facilitating interaction between users and the communication server 102 as part of the communication system 100. According to some embodiments, the modules 124 and 126 may include a chat platform or chat software development kit (chat SDK) 230 operating in conjunction with a chat client 232 for providing a mechanism for users to enter and receive chat communications with other users by way of the chat provider 126 and/or the communication server 102.

Additionally, the modules 124 and 126 may include an authentication sub-module 234 configured to engage with the authentication provider 128 according to the authentication protocol of the authentication provider 128.

The modules 124 and 126 may further include a profile sub-module 236 configured to manage the profile information of the user. For example, the profile module 236 may be configured to collect and store profile information and user data (e.g., in the mass storage device 204 and/or the database 116).

A data feed module 238 may further operate as part of the modules 124 and 126 for receiving data from the data provider 124, the data feed archiver 130, and/or the data feed analyzer 132 about events as part of the communication system 100.

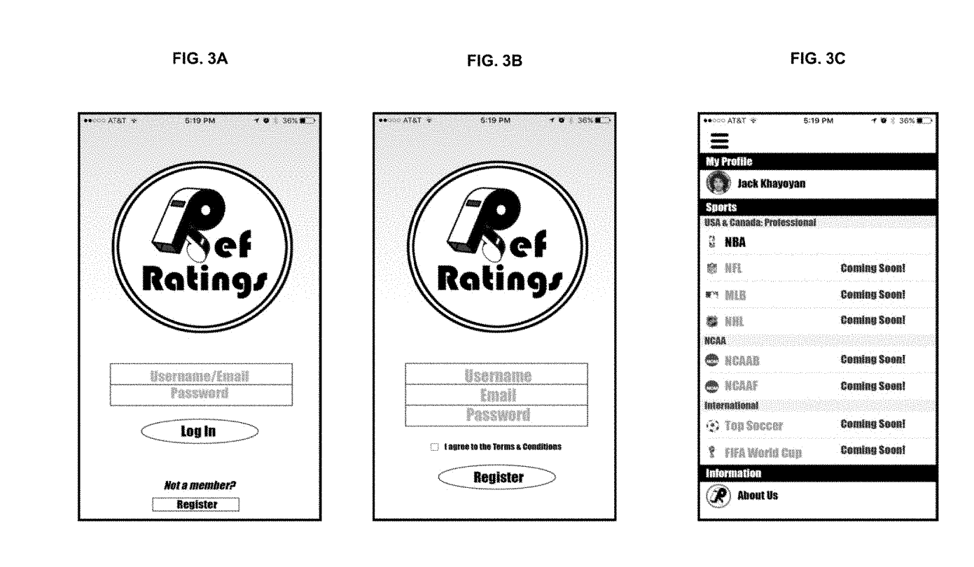

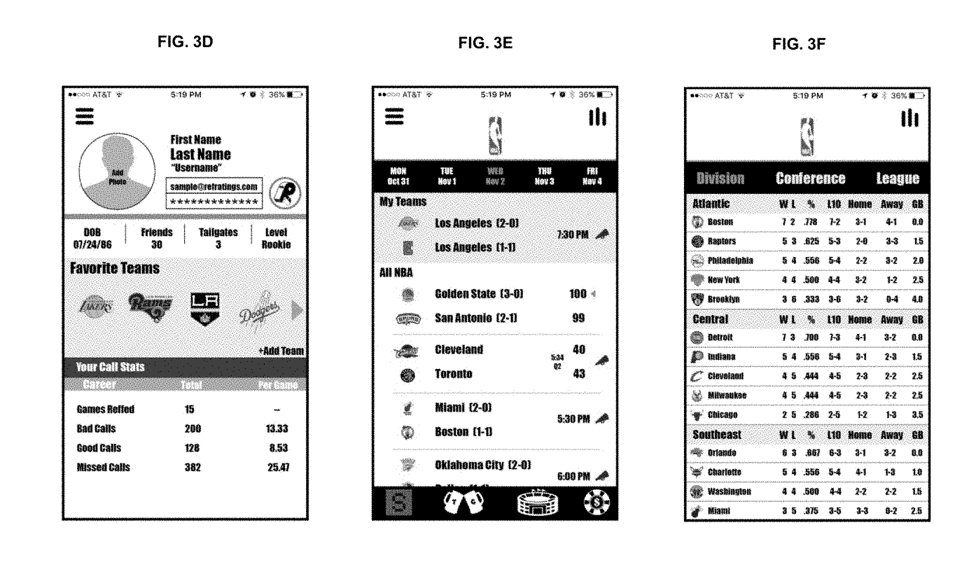

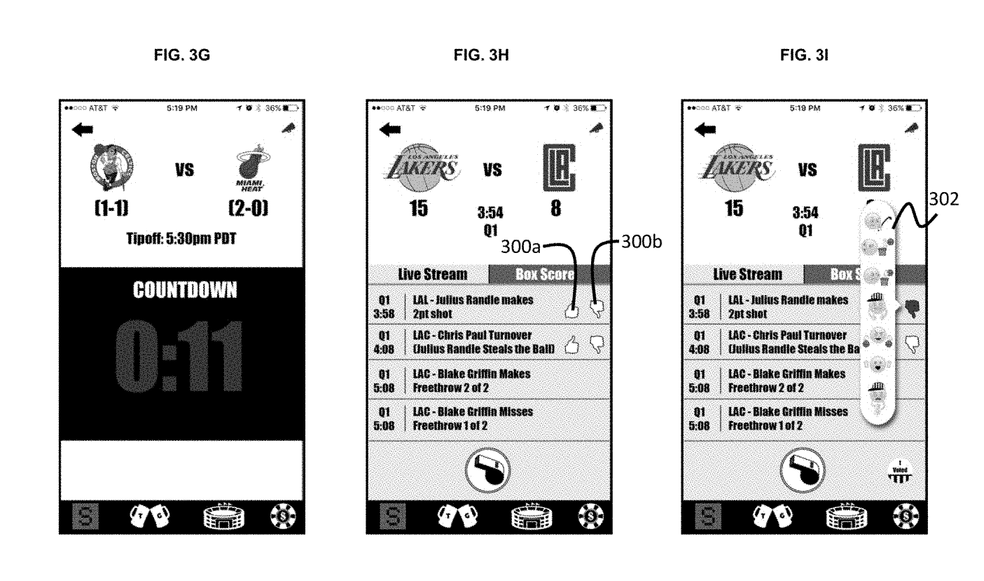

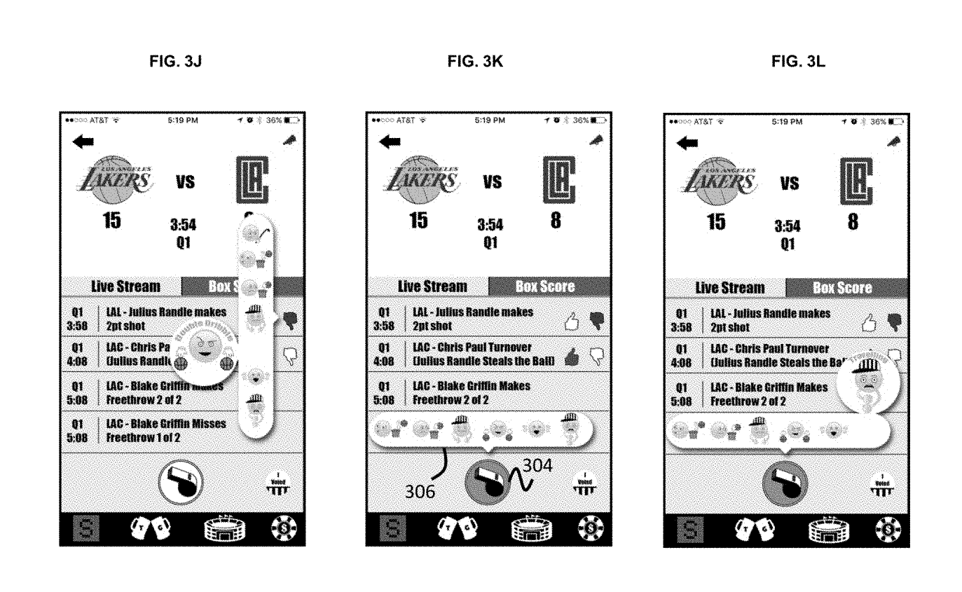

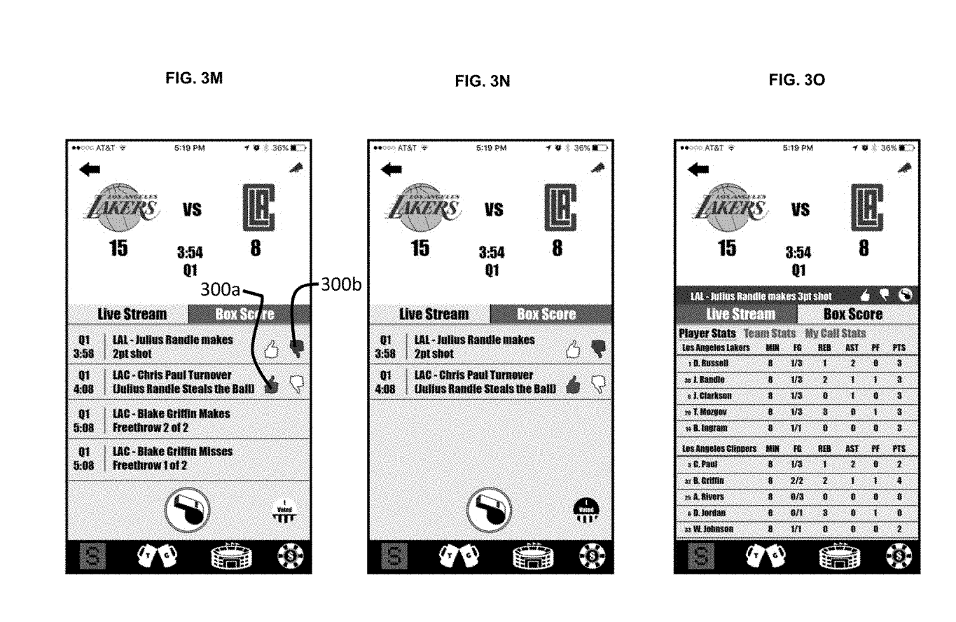

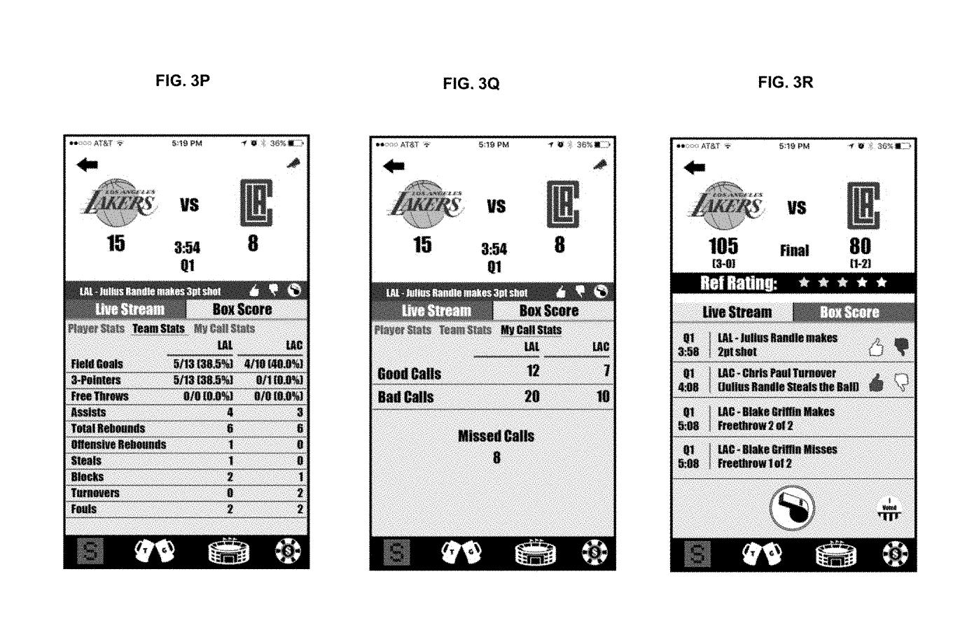

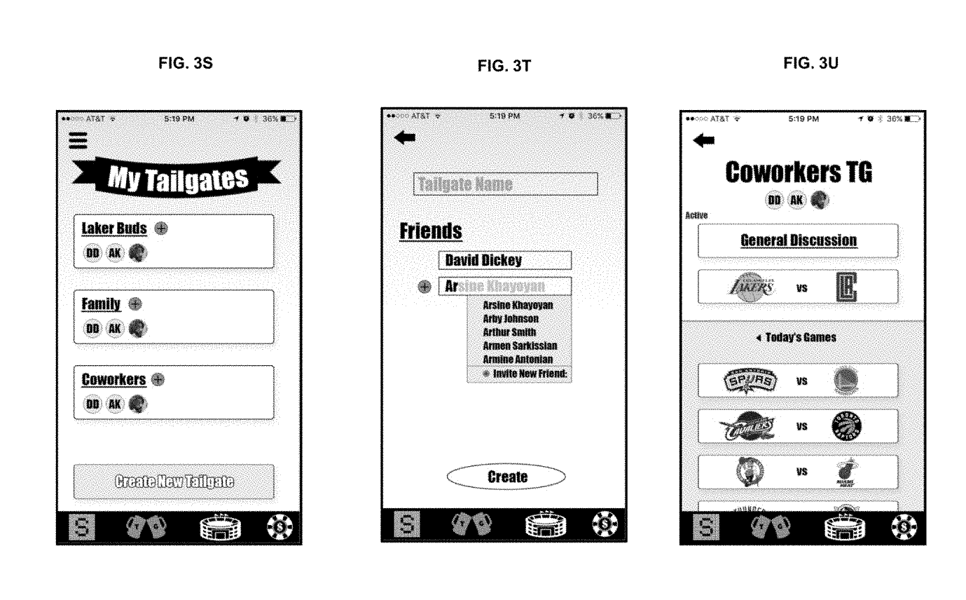

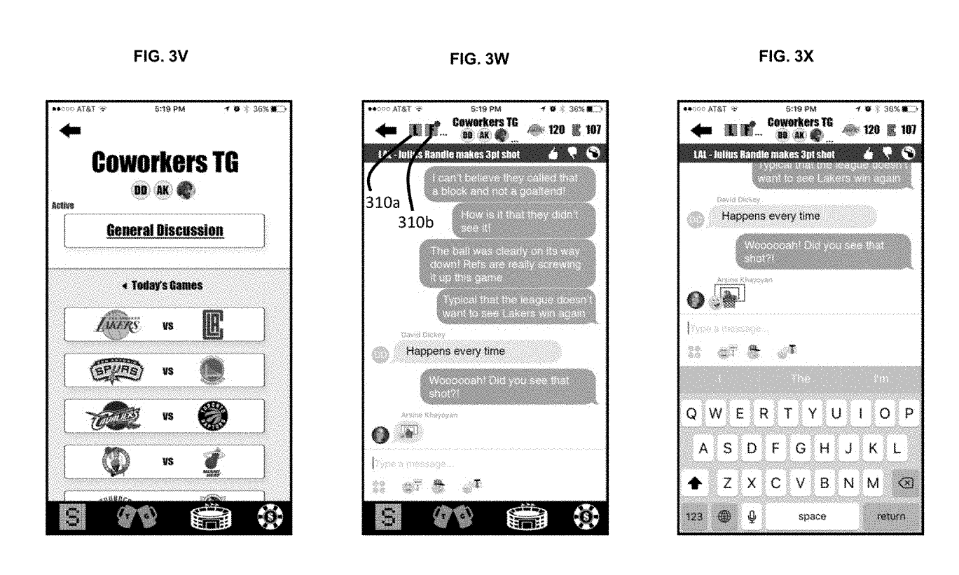

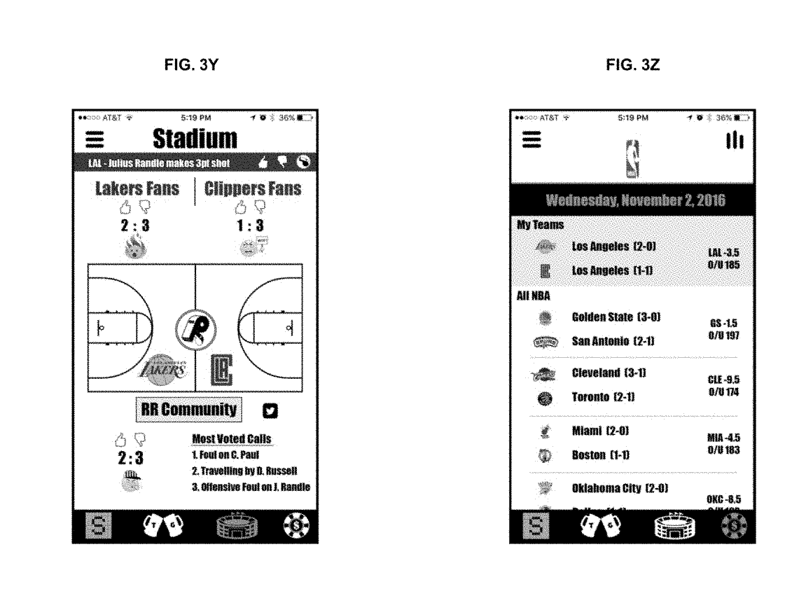

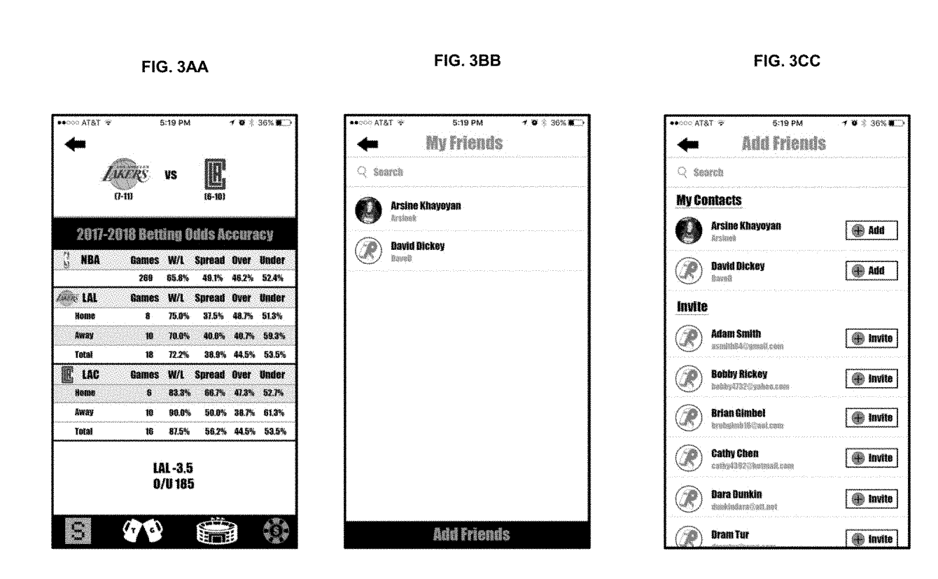

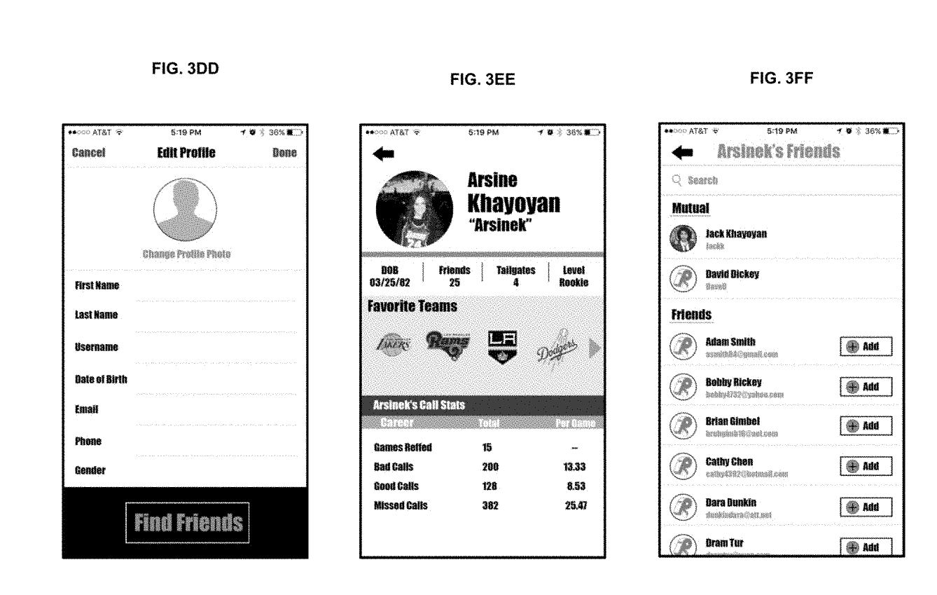

Additionally, in order to enable users to interact with the communication system 100, the modules 124 and 126 may include a user interface module 140 configured to display a plurality of different graphical user interface screens, examples of which are illustrated in FIGS. 3A-3ZZ.

As will be discussed in more detail below, users may interact with the electronic devices 104 and 108, for example, to input information about a sporting event or sports team, for example, to rate or comment on the performance or quality of referees or officials during a sporting event, and exchange communications electronically within the commerce system 100.

Embodiments of the present invention operate to facilitate communications between the user 106 and the user 110 by providing a mechanism for exchanging data between respective electronic devices, and providing a user interface or platform for engaging with one another. For example, the users 106 and 110 may watch a live or time-delayed sporting event, either in person, or on a display device. Through their respective electronic devices 104 and 108 and the communication server 102, the users 106 and 110 may additionally receive relevant data or information about sporting event, sports teams, and/or athletes. As will be explained in more detail below, the users 106 and 110 are then enabled to engage in various forms of communication with one another regarding the event.

FIG. 2 illustrates a relational database structure operating as part of a system for coordinating communication during a real time event, according to some example embodiments of the present invention. As illustrated in FIG. 2, the database 116 may be organized using a relational database structure for storing relevant data and information for the communication system 100. According to some embodiments, the relational database may include the relational tables shown in FIG. 2 and listed in Table 1, below.

TABLE 1

| Table | |
|---|---|
| Name/Category | Information Stored in Table |
| Users | Contains information relating to all the users of the |
| | app, such as name, date of birth, email address, etc. |
| Friends | Contains information on which users are friends. |
| Ratings | Overall referee ratings of each game cast by each |
| | user. |
| TG | Tailgate (chatroom) names created by users. |
| TG Room | Sub-groups of tailgates (chatrooms). Each Tailgate |
| | room may be linked to an event or game in progress. |
| TG Members | A list of which users belong to which Tailgates. |
| Favorites | A list of the favorite teams of each user. |
| Votes | A table of each user's rating of any given event. |
| Games | Contains information on individual games, such as |
| | home team, away team, start time, season, etc. |
| Events | A list of play-by-play events that occur within each |
| | game (for example, as provided by the data provider |
| | 124). |
| Event Details | Details of specific play-by-play events (for example, |
| | as provided by the data provider 124). |
| Event Stats | The effect a particular event had one or more event or |
| | game statistics. |
| League | A list of available sports leagues. |
| Teams | A list of teams and their details. |
| Players | A list of individual players and their details. |
| Team Stats | Team statistics on a particular game. |
| Player Stats | Player statistics on a particular game. |
| Records | Team win/loss/draw records in a season. |
| Game Summary | In Progress game summary information. |
| Refs | A list of referees and their details. |
| Game Refs | A list indicating which refs are officiating which |
| | games. |
| Game Odds | Information on games and their corresponding win/loss |
| | odds, money lines, etc. |

FIGS. 3A-3ZZ illustrate example screen shots of a user interface (e.g., operating in conjunction with or as part of modules 136 and 138) for a system and method for coordinating communication during a real time event, according some example embodiments of the present invention.

FIG. 3A illustrates an example log-in screen. Users who have already created a profile as part of the communication system 100, (i.e., existing members) can enter a username and password to log into the application or user interface. New members will click on the register button to set up their account. The data submitted by the users may then be exchanged with the communication server 102, for example, to authenticate the user's identity and profile information.

FIG. 3B illustrates an example registration screen for the application where users are enabled to register with their contact information (e.g., e-mail address) and create a username and password. The contact information and username and password may be transmitted to the communication server 102 and stored in memory (e.g., database 116), in response to users entering their personal information and selecting a button or icon to register an account or profile with the communication system 100.

FIG. 3C illustrates an example sports or event selection screen. The event selection screen may display profile information about the user, and may have one or more icons or buttons for navigating to other screens of the user interface. Additionally, the event selection screen may include on or more icons or buttons for choosing a category of events for engaging in an interaction with the communication system 110. For example, according to some embodiments, users may be enabled to select from one or more sport categories (e.g., basketball, football, hockey, baseball, soccer, etc.) of events for monitoring individual events and interacting with users during the events.

FIG. 3D illustrates an example “Profile Page” for each user. The profile page may include personal information about users, such as their name, date of birth, friends, chat room associations, level or status, and the like. According to some embodiments, the profile page may be designed similar to a trading card where the user can establish or designate their date of birth, call statistics, favorite teams, etc. Call statistics refers to users' input regarding the performance of referees or officials during sporting events.

FIG. 3E illustrates an example screen showing a real time live stream data and information regarding games or events in progress with the favorite teams' scores being displayed on the top of the screen. According to some embodiments, users may be enabled to select or indicate specific organizations (e.g., specific sports teams) that are favorites of the user to be highlighted or positioned separately (e.g., at the top of the screen) from other organizations. Additionally, according to some embodiments, users may select a game or event for viewing data about the event in real time.

FIG. 3F illustrates an example data screen illustrating statistical information about various organizations (e.g., sports teams) participating in a category of events (e.g., a sports league). For example, in the context of sports teams, the data screen may show the number of wins and losses, win percentages, rankings, and the like.

FIG. 3G illustrates a countdown screen for a game or an event a user is interested in following that has not started yet. It features the current records of the 2 teams playing, the time of the beginning of gameplay (e.g., tipoff, kickoff, etc.), and amount of time remaining for the beginning of gameplay. For example, according to some embodiments, the countdown screen may be displayed in response to a user selecting from among the events illustrated in FIG. 3E, when the event has not yet started.

FIG. 3H illustrates a real time live stream of a specific game in progress where various calls or actions occurring during the course of an event are described and members are given the option the vote on the validity of each call by clicking on buttons or icons 300 (e.g., thumbs up′ or ‘thumbs down’) to indicate approval or disapproval of call. For example, according to some embodiments, for one or more calls or actions (e.g., points scored, referee call, etc.) the icons 300 may include a first icon 300a for indicating approval of or agreement with the call or action and a second icon 300b for indicating disapproval of or disagreement with the call or action. According to some embodiments, in response to a user selecting one of the icons 300, the users electronic device may transmit a signal to the communication server 102 for storing the users selection. Additionally, other users selections may be received and stored by the communication server 102. According to some embodiments, a plurality of user selections may be stored and aggregated, and in some instances the communication system 100 may calculate statistical data such as the average selection or most popular selection and the corresponding percentage of selections. Such aggregated data may then be transmitted in some cases to user's electronic devices for display thereby. Additionally, according to some embodiments, the communication system 100 may be configured to transmit information to users' electronic devices about specific other users' (e.g., friends) selections from among the icons 300a or 300b for display thereby.

FIG. 3I illustrates the real time life stream illustrated in FIG. 3H, with additional icons (e.g., emoticons) 302 to be displayed for users to indicate additional nuanced reactions or emotions related to their selection of the icons 300a or 300b. For example, in response to a user selecting one of the icons 300a or 300b, the communication system 100 may display one or more additional icons 302 that include a graphical depiction of an emotional reaction or opinion. In the context of a sporting event, for example, the additional icons 302 may include one or more symbols or graphical depictions about potential reasons that a user may agree or disagree with a referee's call. For example, in response to a user selecting one of the icons 300a or 300b, the communication system 100 may display one or more additional icons 302 for allowing users to indicate their opinion about a correct or incorrect judgment by a referee about a game violation. According to some embodiments, the communication system 100 may be configured to transmit information to users' electronic devices about specific other users' (e.g., friends) selections from among the icons 300 and the additional icons 302 for display thereby. Additionally, in some embodiments, the communication system 100 may be configured to aggregate a group of users or all users selections from among the icons 300 and the additional icons 302, and transmit information to users' electronic devices about the average vote or the percentage of users who approve or disapprove of a particular call regarding a sub-event.

The users may then select one or more of the additional icons 302 to indicate their approval or disapproval of a call. For example, FIG. 3J illustrates an example selection of an additional icon 302, associated with a particular sub-event occurring during the event (e.g., a basketball scoring a basket) for indicating a user's opinion that a referee failed to properly identify a double dribble violation. The users' selections of the icons 302 may then be transmitted to the communication server 102 and aggregated and stored. According to some embodiments, the aggregated data may be transmitted to user's electronic devices for display thereby.

According to some example embodiments, as illustrated in FIG. 3K, the communication system 100 may be configured to display one or more icons 304 for enabling users to indicate an opinion about a missed call. For example, during the course of an ongoing real time event, users may observe sub-events that are not recorded or displayed as part of the list of sub-events provided by the data provider 124. In the context of a sporting event, for example, if a user believes they have identified a game violation but the violation was not identified by one of the referees and included in the list of sub-events, the user may choose to select the icon 304. In response to a user selecting the icon 304, the communication system 100 may then display one or more additional icons 306, which may include graphical representations of the nature of the missed call or missed game violation.

For example, as illustrated in FIG. 3L, in the context of a basketball game, the additional icons 306 may include an icon for indicating the users' opinion that a player committed a traveling violation that was not identified by one of the referees. According to some embodiments, in response to a user selecting one of the icons 304 and 306, the users electronic device may transmit a signal to the communication server 102 for storing the users selection. Additionally, other users selections may be received and stored by the communication server 102. According to some embodiments, a plurality of user selections may be stored and aggregated, and in some instances the communication system 100 may calculate statistical data such as the average selection or most popular selection and the corresponding percentage of selections. Such aggregated data may then be transmitted in some cases to user's electronic devices for display thereby. Additionally, according to some embodiments, the communication system 100 may be configured to transmit information to users' electronic devices about specific other users' (e.g., friends) selections from among the icons 304 and 306 for display thereby.

As illustrated in FIG. 3M, after a user selects one of the icons 300, the appearance of the selected icon 300 may change to indicate the icon was selected. For example, as illustrated in FIG. 3M, in response to the user selecting the icon 300b corresponding to a first sub-event (“LAL—Julius Randle makes 2pt shot”), the selected icon 300b changes colors from white to red. Similarly, in response to the user selecting the icon 300a associated with a second sub-event (“LAC—Chris Paul Turnover (Julius Randle Steals the Ball)”), the selected icon 300a changes colors from white to green. Embodiments of the present invention are not limited to changing colors of the selected icons, and the change in appearance may include any alternative mechanism or design to indicate the selection of one of the icons (e.g., changed shape, changed icon, etc.). Additionally, according to some embodiments, as illustrated in FIG. 3N, the communication system 100 may be configured to display only sub-events that the user has voted on (e.g., selected one of the icons 300), without displaying any sub-events that the has not voted on. Such a configuration may enable users to more easily re-evaluate or review their votes on the sub-events.

FIG. 3O illustrates a real time live stream box score of the player stats of the game a user is following. The last referee call of the game is listed below the live score on the top of the screen with the option for the viewer to vote on the call by clicking on the ‘thumbs up’ or ‘thumbs down’ icon.

FIG. 3P illustrates a real time live stream box score of the team statistics of the game a user is following. The last referee call of the game is listed below the live score on the top of the screen with the option for the viewer to vote on the call by clicking on the ‘thumbs up’ or ‘thumbs down’ icon.

FIG. 3Q illustrates a screen shot of a graphical display for showing a user's voting or call statistics. For example, according to some embodiments, the communication system 100 may be configured to display a table summarizing the users selections regarding the icons corresponding to the sub-events. As illustrated in FIG. 3Q, the table includes the number of “good calls” (e.g., icon 300a) and the number of “bad calls” (e.g., icon 300b) voted upon by the user. Additionally, in the context of a sporting event, the number of “good calls” and “bad calls” may be illustrated for each team. In some embodiments, the table may further display the number of times the user voted on a missed call (e.g., by selecting the icon 304).

FIG. 3R illustrates a real time live stream upon the completion of a game where users are given the option to vote for the overall performance of referees or officials during the game (e.g., by selecting a certain number of points or stars out of a predetermined maximum number of points or stars). Additionally, according to some embodiments, the votes of a plurality of users may be aggregated and an average score or numerical value may be calculated. The aggregated score may then be transmitted to users' electronic devices for display thereby. In some embodiments, the overall rating, for an individual user, of the referees or officials during an event may be automatically calculated based the user's voting on the sub-events during the event. For example, according to some embodiments, the system may be configured to calculate an overall score for the referees or officials during an event by adding or subtracting a predetermined number from the overall score in response to the user voting approval or disapproval, respectively, for the referee's calls on sub-events. In some embodiments, the communication system 100 may then aggregate the overall referee score for each user to generate an aggregated or average score, which may be transmitted to users' devices for display thereby.

FIG. 3S illustrates an example user interface for group interactions and communications, referred to herein as “tailgates.” Users can create different tailgates wherein they can communicate with other users or members of that tailgate via a group chat during specific games.

FIG. 3T illustrates an example screen or user interface for creating a new tailgate group. Users may enter a name for the tailgate in a text box and invite friends to join the tailgate by entering friends' names in a text box or selecting friends from a menu.

FIG. 3U illustrates an example screen or user interface that appears when a specific tailgate group is selected. The avatars of the members of the group are listed on the top screen. Each tailgate may include an option for engaging in a plurality of chat communication sessions (e.g., 2 chat groups) where, for example, one chat group may be a general chat group that is active at all time in which members can discuss any topics they desire, and another chat group may be based on the specific live game that is occurring. This allows for a space where for friends to discuss the game with one another as well as comment about the refereeing.

FIG. 3V illustrates an example screen or user interface that appears when a specific tailgate group is selected and the only active discussion is the “General Discussion” group and no live games are being discussed.

FIG. 3W illustrates an example screen or user interface that appears when a group chat is taking place among members of a tailgate. On the top of the screen, the last call is displayed with the option of the user to vote on the call by clicking on the ‘thumbs up’ or ‘thumbs down’ icon. Users are enabled to enter text in a text box and the text may be displayed to each of the other users' on their respective electronic devices. According to some embodiments, as illustrated in FIG. 3W, the user interface for the group chat or tailgate may display a real-time updated game score and also a summary or description of the outcome of one or more sub-events (e.g., a most-recent sub-event), while also displaying the chat interface. Users may further be enabled to navigate to other group chats or tailgates by selecting from among one or more buttons or icons 310a and 310b (embodiments of the present invention are not limited to the number of icons illustrated in FIG. 3W, and some embodiments may include additional or fewer icons). Additionally, the communication system 100 may display a notification symbol (e.g., as illustrated by the circle on the icon 310b that is not shown on the icon 310a) to indicate a new message from another member of the group chat.

FIG. 3X illustrates an example screen or user interface that appears when a group chat is taking place among members of a tailgate in which one of the members is in the progress of typing a text. The standard keyboard screen appears on the bottom of the screen with the most commonly used symbols or emojis displayed just above the keyboard.

FIG. 3Y illustrates an example user interface or screen referred to herein as the “Stadium,” in which users are provided with aggregate data based on real-time votes from both fans of the team competing in the specific game as well as general viewers of the game and their impressions on the quality of the refereeing. It allows users to see which calls were the most voted on by all users.

FIG. 3Z illustrates an example user interface or screen for displaying the betting odds for the games that are taking place on a specific day. The information provided may include, for example, betting lines provided from sportsbooks or oddsmakers.

FIG. 3AA illustrates an example user interface or screen for displaying betting odds accuracy in response to a user selecting a matchup from one of the games or events listed in the interface shown in FIG. 3Z. As shown in FIG. 3AA, the communication system 100 may be configured to show how often historical odds have been accurate in terms of selecting the winner, predicting the spread, and how often the score is over/under the stated over/under prediction.

FIG. 3BB illustrates an example user interface for viewing a list of “friends” or connections to other users. According to some embodiments, users may be enabled to view information about other users (such as profile information, statistical information, preference information, etc.) by selecting the other user's name or screen name. Additionally, according to some embodiments, users may be enabled to invite “friends” to a group chat session or transmit messages to their “friends.”

FIG. 3CC illustrates an example user interface for adding “friends” or other users to a network of connected users. According to some embodiments, the communication system 100 may access a list of contacts stored on the user's electronic device and display a list of existing users operating electronic devices connected to the communication system 100 who are also stored in the list of contacts on the user's electronic device. Additionally, according to some embodiments the communication system 100 may include an interface for transmitting a message or signal to invite other users to connect to the communication system 100.

FIG. 3DD illustrates a user interface for enabling users to provide user profile information, such as their name, username, date of birth, email, phone number, gender, and the like. According to some embodiments, the user profile information may be stored in memory (e.g., the database 116), and certain user profile information may be accessible or visible to other users operating electronic device connected to the communication system 100. For example, as illustrated in FIG. 3EE, according to some embodiments, users may be enabled to view user profile information of other users who are connected to (i.e., “friends with”) them. Additionally, in some embodiments, as illustrated in FIG. 3FF, users may be able to view a list of friends or connections of other users, and submit requests to become connected to the those other users.

FIG. 3GG illustrates a plurality of example symbols for use as part of a user interface for a system and method for coordinating communication during a real time event, according some example embodiments of the present invention. The symbols may be displayed in response to a user voting on a call or during a chat communication session, to enable users to provide a graphical or symbolic description of their opinion or emotion.

Various data and information discussed above with respect to FIGS. 3A-3GG for display on users' electronic devices may, in some instances, be received from a third party data source (e.g., third party data provider 124 or media provider 122) and aggregated at the communication server 102 before being transmitted to the users' electronic devices, or the data may be transmitted directly to users' electronic devices from the third party data provider.

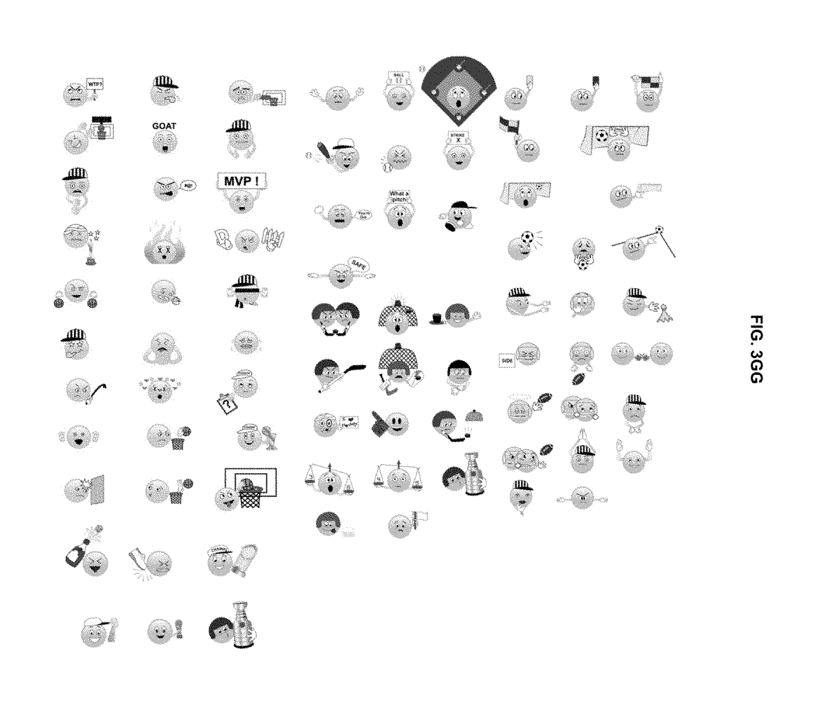

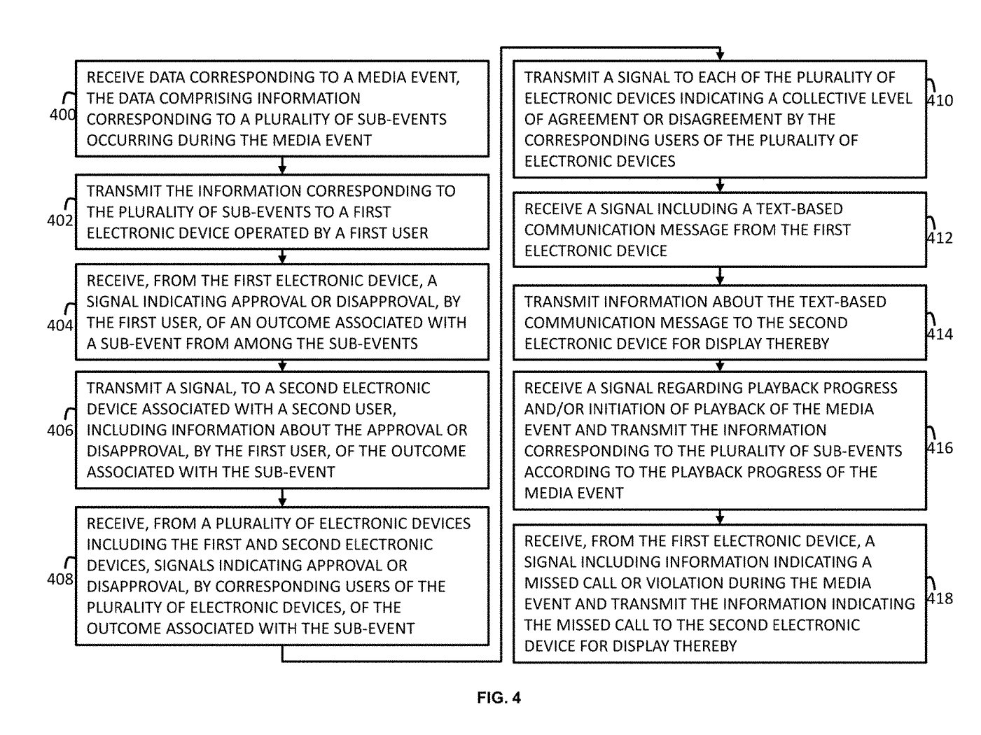

FIG. 4 is a flow diagram illustrating a process for coordinating communication during a real time event, according to some example embodiments of the present invention. According to some embodiments, the number and order of operations illustrated in FIG. 4 may vary according to the design and implementation of the communication system 100. For example, the communication system 100 may execute fewer or additional operations in various embodiments, and the order of the operations may be different in various embodiments, unless otherwise stated, without departing from the spirit and scope of the present invention.

As illustrated in FIG. 4, at 400, the communication system 100 receives data (e.g., from the data provider 124) corresponding to a media event, such as a broadcast of a television program, sporting event, competition, etc. The data corresponding to the media event may include information about or corresponding to a plurality of sub-events occurring during the media event. For example, in the context of a sporting event, the communication system 100 may receive data about various sub-events such as yards gained or lost, play attempts, points scored, violations, time-outs, and the like. The data may include information describing the nature or type of the sub-events, the time the sub-events occurred, and the outcome of the sub-events (e.g., which people, players, or teams were involved, points scored, penalties incurred, violations, yards gained/lost, etc.).

The data may archived by the data feed archiver 130 and stored (e.g., in database 116). Additionally, the data may be analyzed and/or converted by the data feed analyzer 132 into a format or condition such that the data can be transmitted to one or more user electronic devices for display thereby.

At 402, the communication system 100 may transmit the data (and/or information about the data) corresponding to the plurality of sub-events to one or more electronic devices (e.g., a first electronic device) operated by one or more users (e.g., a first user). Information about the sub-event may then be displayed on the one or more electronic devices, whereby users are enabled to indicate whether or not the users agree with the outcome of the sub-event. For example, a user operating an electronic device 104 may observe the media event (e.g., a broadcast or stream of the data event) by way of a display device in electronic communication with the media provider 122. The display device may be integrated into the electronic device 104, or may be a separate device (e.g., a television, laptop computer, tablet computer, etc.) configured to receive and display video and/or audio data. In response to the communication system 100 transmitting information about sub-events occurring during the media event to the electronic device 104, the user may provide a user input to the electronic device 104 (e.g., by selecting one of the icons 300, 302, 304, 306) indicating approval or disapproval of the outcome of the sub-event. For example, the user may indicate, by way of the user input, approval/agreement or disapproval/disagreement with a judgement by a referee or official.

At 404, the user input is then transmitted to and received by the communication server 102 as a signal indicating approval or disapproval, by the user, of the outcome associated with a sub-event from among the sub-events. The data corresponding to the signal of the user input (e.g., the data representing the user's approval or disapproval) may then be stored (e.g., in the database 116). In some embodiments, the data corresponding to the signals of the user input from multiple users may be received, stored, and aggregated to generate aggregated data reflecting a plurality of users' approval or disapproval.

At 406, the communication system 100 may transmit a signal, to a second electronic device associated with a second user, including information about the approval or disapproval, by the first user, of the outcome associated with the sub-event.

At 408, in some embodiments, the communication system 100 may receive, from a plurality of electronic devices (including the first and second electronic devices) signals indicating approval or disapproval, by corresponding users of the plurality of electronic devices, of the outcome associated with a sub-event, which may be stored and aggregated. Users may then receive the information about multiple other users' approval or disapproval of the outcome of a sub-event, which may be displayed on their corresponding electronic devices. For example, at 410, the communication system 100 may transmit a signal to each of the plurality of electronic devices indicating a collective level of agreement or disagreement by the corresponding users of the plurality of the electronic devices about the outcome of one or more sub-events.

According to some embodiments, the communication system 100 may further operate as a platform for facilitating text-based communications. For example, at 412, the communication system 100 may receive a signal including a text-based communication message from the first electronic device, and at 414, the communication system 100 may transmit information about the text-based communication message to the second electronic device for display thereby.

Additionally, according to some embodiments, the communication system 100 may facilitate communication about and during a time-delayed playback of a media event. For example, in some embodiments, a media broadcast may be recorded or stored in memory on an electronic device accessible to or operated by a user. The electronic device may include a digital video recorder (DVR), computer system, media streaming platform, or any other electronic device configured to store and transmit media data to a display panel. According to some embodiments, the electronic device for storing and transmitting media data may be incorporated into the electronic device 104 or 108, or may be external with respect to the electronic device 104 or 108.

The communication system 100 may be in electronic communication with the electronic device for storing and transmitting media data, and may be configured to automatically receive, from the electronic device, information indicating the playback progress and/or initiation of playback of the media event on a display device. In other embodiments, users may provide user input, by way of the electronic devices 104 and 108, that includes information indicating the playback progress and/or initiation of playback of the media event. Then, at 416, the communication system 100 may receive a signal regarding the playback progress and/or initiation of playback of the media event, and transmit the information corresponding to the plurality of sub-events according to the playback status or progress of the media event. Accordingly, the communication system 100 may be configured to transmit or display the information about the plurality of sub-events to/on user devices 104 and 108 in synchronization with the time-delayed playback of the media event. In such instances, the communication system 100 may wait until after sub-events have occurred or been displayed during the time-delayed playback before transmitting the information about the sub-events or allowing the information about the sub-events to be displayed on the user's electronic device.

Additionally, as described above with respect to FIG. 3K, at 418, the communication system 100 may receive, from a first electronic device, a signal including information indicating user's opinion about a missed call or violation by referees or officials during a media event. The information may then be transmitted to a second electronic device for display thereby. According to some embodiments, the communication system 100 may receive, store, and aggregate a plurality of users' opinions about a missed call or violation, and transmit/display the aggregated users' opinions to users' electronic devices.

Thus, as described above and illustrated in the accompanying figures, embodiments of the present invention provide a platform for facilitating electronic communications between users. In particular, embodiments of the present invention enable users having a shared interest in one or more events (e.g., sporting events) or organizations (e.g., sports teams) to provide real-time input, feedback, and commentary regarding various aspects of a sporting event, for example, regarding the performance of referees and officials. Users may, for example, rate or vote on the quality of decisions or calls made by referees or officials, and discuss the referee performance, and other aspects of sporting events, with one another using various communication interfaces or channels such as chat.

In addition to providing users a platform and interface for actively providing communal input on decisions, calls, or non-calls made by referees or officials, embodiments of the present invention may also provide a platform for group communication or chat sessions and also replaying past plays (e.g., the most-recent play) that occurred during a sporting event. Users can also view the general reactions of other members or a community of users watching a particular sporting event, and receive data regarding the aggregated opinions or input received from a plurality of users. User input (e.g., opinions, voting surveys, etc.) received from a plurality of users is collected and statistical analysis may be performed and displayed to users regarding users' opinions about different referees or officials. User input may also be utilized to establish refereeing trends, encourage referee transparency and accountability, and to enable sports teams, media outlets, and the general public to more thoroughly understand fans' perception of the fairness and quality of refereeing.

Although some example embodiments have been described in the context communications occurring in the context of sporting events, some embodiments of the present invention may be applied on other contexts, and may include other events (e.g., reality television programs, political debates, etc.) in which users may communicate with each other in real time and exchange opinions about activities occurring during the events.

In one embodiment, each of the various servers, controllers, switches, gateways, engines, and/or modules (collectively referred to as servers) in the afore-described figures are implemented via hardware or firmware (e.g. ASIC) as will be appreciated by a person of skill in the art.

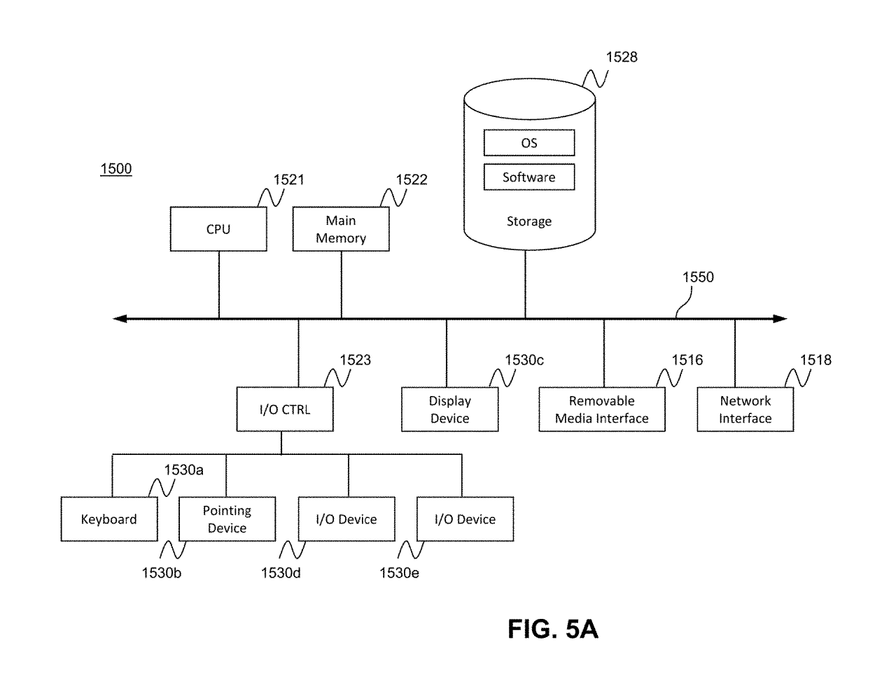

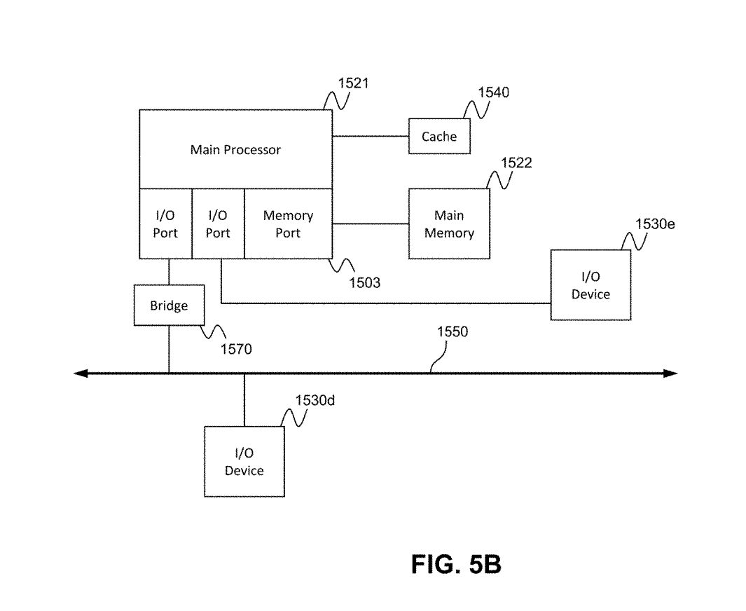

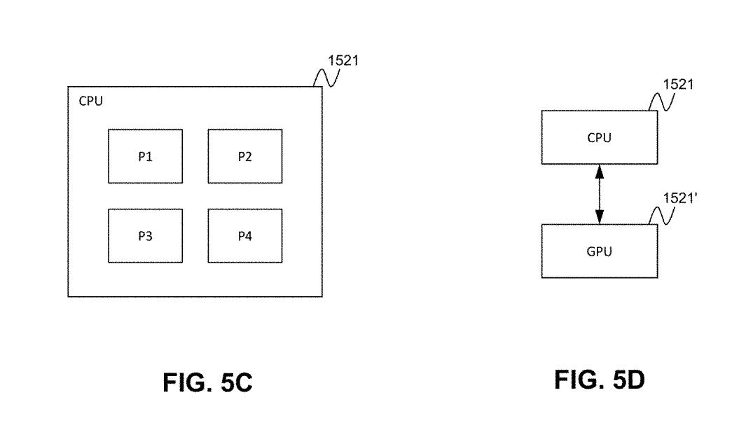

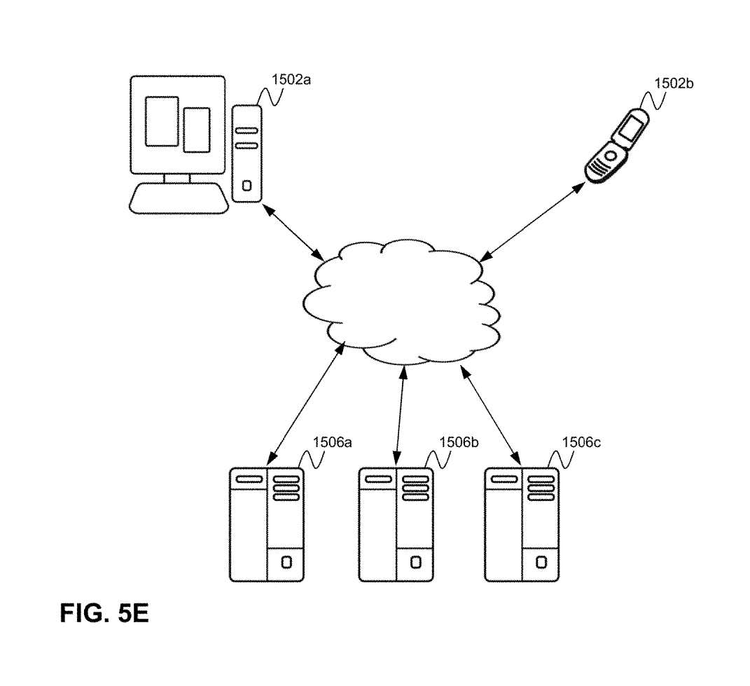

In one embodiment, each of the various servers, controllers, engines, and/or modules (collectively referred to as servers) in the afore-described figures may be a process or thread, running on one or more processors, in one or more computing devices 1500 (e.g., FIG. 5A, FIG. 5B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments of the present invention, functionality provided by servers located on computing devices off-site may be accessed and provided over a virtual private network (VPN) as if such servers were on-site, or the functionality may be provided using a software as a service (SaaS) to provide functionality over the internet using various protocols, such as by exchanging data using encoded in extensible markup language (XML) or JavaScript Object notation (JSON).

FIG. 5A and FIG. 5B depict block diagrams of a computing device 1500 as may be employed in exemplary embodiments of the present invention. Each computing device 1500 includes a central processing unit 1521 and a main memory unit 1522. As shown in FIG. 5A, the computing device 1500 may also include a storage device 1528, a removable media interface 1516, a network interface 1518, an input/output (I/O) controller 1523, one or more display devices 1530c, a keyboard 1530a and a pointing device 1530b, such as a mouse. The storage device 1528 may include, without limitation, storage for an operating system and software. As shown in FIG. 5B, each computing device 1500 may also include additional optional elements, such as a memory port 1503, a bridge 1570, one or more additional input/output devices 1530d, 1530e and a cache memory 1540 in communication with the central processing unit 1521. The input/output devices 1530a, 1530b, 1530d, and 1530e may collectively be referred to herein using reference numeral 1530.

The central processing unit 1521 is any logic circuitry that responds to and processes instructions fetched from the main memory unit 1522. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1522 may be one or more memory chips capable of storing data and allowing any storage location to be directly accessed by the central processing unit 1521. As shown in FIG. 5A, the central processing unit 1521 communicates with the main memory 1522 via a system bus 1550. As shown in FIG. 5B, the central processing unit 1521 may also communicate directly with the main memory 1522 via a memory port 1503.

FIG. 5B depicts an embodiment in which the central processing unit 1521 communicates directly with cache memory 1540 via a secondary bus, sometimes referred to as a backside bus. In other embodiments, the central processing unit 1521 communicates with the cache memory 1540 using the system bus 1550. The cache memory 1540 typically has a faster response time than main memory 1522. As shown in FIG. 5A, the central processing unit 1521 communicates with various I/O devices 1530 via the local system bus 1550. Various buses may be used as the local system bus 1550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1530c, the central processing unit 1521 may communicate with the display device 1530c through an Advanced Graphics Port (AGP). FIG. 5B depicts an embodiment of a computer 1500 in which the central processing unit 1521 communicates directly with I/O device 1530e. FIG. 5B also depicts an embodiment in which local busses and direct communication are mixed: the central processing unit 1521 communicates with I/O device 1530d using a local system bus 1550 while communicating with I/O device 1530e directly.

A wide variety of I/O devices 1530 may be present in the computing device 1500. Input devices include one or more keyboards 1530a, mice, trackpads, trackballs, microphones, and drawing tablets. Output devices include video display devices 1530c, speakers, and printers. An I/O controller 1523, as shown in FIG. 5A, may control the I/O devices. The I/O controller may control one or more I/O devices such as a keyboard 1530a and a pointing device 1530b, e.g., a mouse or optical pen.

Referring again to FIG. 5A, the computing device 1500 may support one or more removable media interfaces 1516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 1530 may be a bridge between the system bus 1550 and a removable media interface 1516.

The removable media interface 1516 may for example be used for installing software and programs. The computing device 1500 may further comprise a storage device 1528, such as one or more hard disk drives or hard disk drive arrays, for storing an operating system and other related software, and for storing application software programs. Optionally, a removable media interface 1516 may also be used as the storage device. For example, the operating system and the software may be run from a bootable medium, for example, a bootable CD.

In some embodiments, the computing device 1500 may comprise or be connected to multiple display devices 1530c, which each may be of the same or different type and/or form. As such, any of the I/O devices 1530 and/or the I/O controller 1523 may comprise any type and/or form of suitable hardware, software, or combination of hardware and software to support, enable or provide for the connection to, and use of, multiple display devices 1530c by the computing device 1500. For example, the computing device 1500 may include any type and/or form of video adapter, video card, driver, and/or library to interface, communicate, connect or otherwise use the display devices 1530c. In one embodiment, a video adapter may comprise multiple connectors to interface to multiple display devices 1530c. In other embodiments, the computing device 1500 may include multiple video adapters, with each video adapter connected to one or more of the display devices 1530c. In some embodiments, any portion of the operating system of the computing device 1500 may be configured for using multiple display devices 1530c. In other embodiments, one or more of the display devices 1530c may be provided by one or more other computing devices, connected, for example, to the computing device 1500 via a network. These embodiments may include any type of software designed and constructed to use the display device of another computing device as a second display device 1530c for the computing device 1500. One of ordinary skill in the art will recognize and appreciate the various ways and embodiments that a computing device 1500 may be configured to have multiple display devices 1530c.

A computing device 1500 of the sort depicted in FIG. 5A and FIG. 5B may operate under the control of an operating system, which controls scheduling of tasks and access to system resources. The computing device 1500 may be running any operating system, any embedded operating system, any real-time operating system, any open source operating system, any proprietary operating system, any operating systems for mobile computing devices, or any other operating system capable of running on the computing device and performing the operations described herein.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In other embodiments the computing device 1500 is a mobile device, such as a Java-enabled cellular telephone or personal digital assistant (PDA), a smart phone, a digital audio player, or a portable media player. In some embodiments, the computing device 1500 comprises a combination of devices, such as a mobile phone combined with a digital audio player or portable media player.

As shown in FIG. 5C, the central processing unit 1521 may comprise multiple processors P1, P2, P3, P4, and may provide functionality for simultaneous execution of instructions or for simultaneous execution of one instruction on more than one piece of data. In some embodiments, the computing device 1500 may comprise a parallel processor with one or more cores. In one of these embodiments, the computing device 1500 is a shared memory parallel device, with multiple processors and/or multiple processor cores, accessing all available memory as a single global address space. In another of these embodiments, the computing device 1500 is a distributed memory parallel device with multiple processors each accessing local memory only. In still another of these embodiments, the computing device 1500 has both some memory which is shared and some memory which may only be accessed by particular processors or subsets of processors. In still even another of these embodiments, the central processing unit 1521 comprises a multicore microprocessor, which combines two or more independent processors into a single package, e.g., into a single integrated circuit (IC). In one exemplary embodiment, depicted in FIG. 5D, the computing device 1500 includes at least one central processing unit 1521 and at least one graphics processing unit 1521′.

In some embodiments, a central processing unit 1521 provides single instruction, multiple data (SIMD) functionality, e.g., execution of a single instruction simultaneously on multiple pieces of data. In other embodiments, several processors in the central processing unit 1521 may provide functionality for execution of multiple instructions simultaneously on multiple pieces of data (MIMD). In still other embodiments, the central processing unit 1521 may use any combination of SIMD and MIMD cores in a single device.

A computing device may be one of a plurality of machines connected by a network, or it may comprise a plurality of machines so connected. FIG. 5E shows an exemplary network environment. The network environment comprises one or more local machines 1502a, 1502b (also generally referred to as local machine(s) 1502, client(s) 1502, client node(s) 1502, client machine(s) 1502, client computer(s) 1502, client device(s) 1502, endpoint(s) 1502, or endpoint node(s) 1502) in communication with one or more remote machines 1506a, 1506b, 1506c (also generally referred to as server machine(s) 1506 or remote machine(s) 1506) via one or more networks 1504. In some embodiments, a local machine 1502 has the capacity to function as both a client node seeking access to resources provided by a server machine and as a server machine providing access to hosted resources for other clients 1502a, 1502b. Although only two clients 1502 and three server machines 1506 are illustrated in FIG. 5E, there may, in general, be an arbitrary number of each. The network 1504 may be a local-area network (LAN), e.g., a private network such as a company Intranet, a metropolitan area network (MAN), or a wide area network (WAN), such as the Internet, or another public network, or a combination thereof.

The computing device 1500 may include a network interface 1518 to interface to the network 1504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 1500 communicates with other computing devices 1500 via any type and/or form of gateway or tunneling protocol such as Secure Socket Layer (SSL) or Transport Layer Security (TLS). The network interface 1518 may comprise a built-in network adapter, such as a network interface card, suitable for interfacing the computing device 1500 to any type of network capable of communication and performing the operations described herein. An I/O device 1530 may be a bridge between the system bus 1550 and an external communication bus.

According to one embodiment, the network environment of FIG. 5E may be a virtual network environment where the various components of the network are virtualized. For example, the various machines 1502 may be virtual machines implemented as a software-based computer running on a physical machine. The virtual machines may share the same operating system. In other embodiments, different operating system may be run on each virtual machine instance. According to one embodiment, a “hypervisor” type of virtualization is implemented where multiple virtual machines run on the same host physical machine, each acting as if it has its own dedicated box. Of course, the virtual machines may also run on different host physical machines.

Other types of virtualization are also contemplated, such as, for example, the network (e.g. via Software Defined Networking (SDN)). Functions, such as functions of the session border controller and other types of functions, may also be virtualized, such as, for example, via Network Functions Virtualization (NFV).

Although this invention has been described in certain specific embodiments, those skilled in the art will have no difficulty devising variations to the described embodiment, which in no way depart from the scope and spirit of the present invention. Furthermore, to those skilled in the various arts, the invention itself herein will suggest solutions to other tasks and adaptations for other applications. It is the applicant's intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A communication system comprising:
a processor; and
a memory coupled to the processor, wherein the memory stores instructions that, when executed by the processor, cause the processor to:
receive data corresponding to a media event, the data comprising information corresponding to a plurality of sub-events occurring during the media event;
transmit the information corresponding to the plurality of sub-events to a first electronic device operated by a first user;
receive, from the first electronic device, a signal indicating approval or disapproval, by the first user, of an outcome associated with a sub-event from among the sub-events; and
transmit a signal, to a second electronic device associated with a second user, including information about the approval or disapproval, by the first user, of the outcome associated with the sub-event.

2. The communication system of claim 1, wherein the instructions further cause the processor to receive, from a plurality of electronic devices including the first and second electronic devices, signals indicating approval or disapproval, by corresponding users of the plurality of electronic devices, of the outcome associated with the sub-event.

3. The communication system of claim 2, wherein the instructions further cause the processor to transmit a signal to each of the plurality of electronic devices indicating a collective level of agreement or disagreement of the by the corresponding users of the plurality of electronic devices.

4. The communication system of claim 1, wherein the instructions further cause the processor to:
receive a signal including a text-based communication message from the first electronic device; and
transmit information about the text-based communication message to the second electronic device for display thereby.

5. The communication system of claim 1, wherein the instructions further cause the processor to:
receive a signal regarding playback progress of the media event; and
transmit the information corresponding to the plurality of sub-events according to the playback progress of the media event.

6. The communication system of claim 5, wherein the instructions further cause the processor to:
receive, from the first electronic device, a signal indicating initiation of playback of the media event; and
transmit the information corresponding to the plurality of sub-events to the first electronic device in response to receiving the signal indicating initiation of playback of the media event.

7. The communication system of claim 1, wherein the instructions further cause the processor to:
receive, from the first electronic device, a signal including information about a reason for the approval or disapproval of the outcome associated with the sub-event; and
transmit the information about the reason for approval or disapproval of the outcome associated with the sub-event to the second electronic device for display thereby.

8. The communication system of claim 1, wherein the instructions further cause the processor to:
receive, from the first electronic device, a signal including information indicating a missed call during the media event; and
transmit the information indicating the missed call to the second electronic device for display thereby.

9. The communication system of claim 8, wherein the instructions further cause the processor to:
receive, from the first electronic device, a signal including information about a reason for the missed call during the media event; and
transmit the information about the reason for the missed call to the second electronic device for display thereby.

10. The communication system of claim 1, wherein the instructions further cause the processor to:
store information about approval or disapproval, by the first user, of outcomes associated with multiple sub-events from among the plurality of sub-events; and
transmit a signal to the first electronic device for displaying a summary of the approval or disapproval of the outcomes associated with the multiple sub-events.

11. A communication method comprising:
receiving, by a processor, data corresponding to a media event, the data comprising information corresponding to a plurality of sub-events occurring during the media event;
transmitting, by the processor, the information corresponding to the plurality of sub-events to a first electronic device operated by a first user;
receiving, by the processor, from the first electronic device, a signal indicating approval or disapproval, by the first user, of an outcome associated with a sub-event from among the sub-events; and
transmitting, by the processor, a signal, to a second electronic device associated with a second user, including information about the approval or disapproval, by the first user, of the outcome associated with the sub-event.

12. The communication method of claim 11, further comprising receiving, by the processor, from a plurality of electronic devices including the first and second electronic devices, signals indicating approval or disapproval, by corresponding users of the plurality of electronic devices, of the outcome associated with the sub-event.

13. The communication method of claim 12, further comprising transmitting, by the processor a signal to each of the plurality of electronic devices indicating a collective level of agreement or disagreement of the by the corresponding users of the plurality of electronic devices.

14. The communication method of claim 11, further comprising:
receiving, by the processor, a signal including a text-based communication message from the first electronic device; and
transmitting, by the processor, information about the text-based communication message to the second electronic device for display thereby.

15. The communication method of claim 11, further comprising:
receiving, by the processor, a signal regarding playback progress of the media event; and
transmitting, by the processor, the information corresponding to the plurality of sub-events according to the playback progress of the media event.

16. The communication method of claim 15, further comprising:
receiving, by the processor, from the first electronic device, a signal indicating initiation of playback of the media event; and
transmitting, by the processor, the information corresponding to the plurality of sub-events to the first electronic device in response to receiving the signal indicating initiation of playback of the media event.

17. The communication method of claim 11, further comprising:
receiving, by the processor, from the first electronic device, a signal including information about a reason for the approval or disapproval of the outcome associated with the sub-event; and
transmitting, by the processor, the information about the reason for approval or disapproval of the outcome associated with the sub-event to the second electronic device for display thereby.

18. The communication method of claim 11, further comprising:
receiving, by the processor, from the first electronic device, a signal including information indicating a missed call during the media event; and
transmitting, by the processor, the information indicating the missed call to the second electronic device for display thereby.

19. The communication method of claim 18, further comprising:
receiving, by the processor, from the first electronic device, a signal including information about a reason for the missed call during the media event; and
transmitting, by the processor, the information about the reason for the missed call to the second electronic device for display thereby.

20. The communication method of claim 11, further comprising:
storing, by the processor, information about approval or disapproval, by the first user, of outcomes associated with multiple sub-events from among the plurality of sub-events; and
transmitting, by the processor, a signal to the first electronic device for displaying a summary of the approval or disapproval of the outcomes associated with the multiple sub-events.
